(19) United States
(12) Patent Application Publication
(10) Pub. No.: US 2025/0245790 A1
(43) Pub. Date: Jul. 31, 2025

(54) VEHICULAR VISION SYSTEM WITH ENHANCED IMAGE PROCESSING

(71) Applicant: Magna Electronics Inc., Auburn Hills, MI (US)

(72) Inventors: Surya Prakash Ramanujam, Tamil Nadu (IN); Pradeep N. Kundar, Karnataka (IN); P. Preranaa, Karnataka (IN)

(21) Appl. No.: 19/039,826

(22) Filed: Jan. 29, 2025

Related U.S. Application Data
(60) Provisional application No. 63/626,675, filed on Jan. 30, 2024.

(51) Int. Cl. G06T 5/60; B60W 50/00; G06T 7/00; H04N 7/18

(52) U.S. Cl. CPC G06T 5/60; G06T 7/0002; H04N 7/183; B60W 50/00; B60W 2420/403; G06T 2207/20084; G06T 2207/30168; G06T 2207/30261

(57) ABSTRACT

A vehicular vision system includes a camera disposed at a vehicle equipped with the vehicular vision system. The camera views exterior of the vehicle. The camera is operable to capture frames of image data. The system includes an electronic control unit (ECU). The vehicular vision system determines, at least in part via processing at the ECU of frames of image data captured by the camera and transferred to the ECU, whether a quality of a frame of image data satisfies a quality threshold. Based at least in part on determining that the quality of the frame of image data fails to satisfy the quality threshold, the vehicular vision system enhances the frame of image data, and the enhanced frame of image data is processed at the ECU for an advanced driving assistance system (ADAS) of the vehicle.

### CROSS REFERENCE TO RELATED APPLICATION

The present application claims the filing benefits of U.S. provisional application Ser. No. 63/626,675, filed Jan. 30, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a camera disposed at a vehicle equipped with the vehicular vision system. The camera views exterior of the vehicle. The camera is operable to capture frames of image data. The camera includes a CMOS imaging array with at least one million photosensors arranged in rows and columns. The system includes an electronic control unit (ECU) with electronic circuitry and associated software. Frames of image data captured by the camera are transferred to and are processed at the ECU. The vehicular vision system determines, at least in part via processing at the ECU of frames of image data captured by the camera and transferred to the ECU, whether a quality of a frame of image data satisfies a quality threshold. Based at least in part on determining that the quality of the frame of image data fails to satisfy the quality threshold, the vehicular vision system enhances the frame of image data, and the enhanced frame of image data is processed at the ECU for an advanced driving assistance system (ADAS) of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIGS. 2A and 2B are example images of nighttime glare and daytime glare;

FIG. 3 is a block diagram of the vision system of FIG. 1;

FIG. 4 is a detailed block diagram of the vision system of FIG. 1;

FIG. 5 is a block diagram of a nighttime glare enhancement function of the vision system of FIG. 1;

FIG. 6 is a block diagram of a daytime glare enhancement function of the vision system of FIG. 1;

FIG. 7 is example images of detection improvement based on enhancement of images by the vision system of FIG. 1;

FIGS. 8A-8C are example images of glare detection by the vision system of FIG. 1;

FIG. 9 is a block diagram of a nighttime glare enhancement function of the vision system of FIG. 1 with example images;

FIG. 10 is a block diagram of a daytime glare enhancement function of the vision system of FIG. 1 with example images;

FIG. 11 is example images of detection performance reduction based on enhancement of images;

FIGS. 12A-12D are example images of improved confidence and reduced false positives using the vision system of FIG. 1; and

FIGS. 13A-13D are example images of increased true positives using the vision system of FIG. 1.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

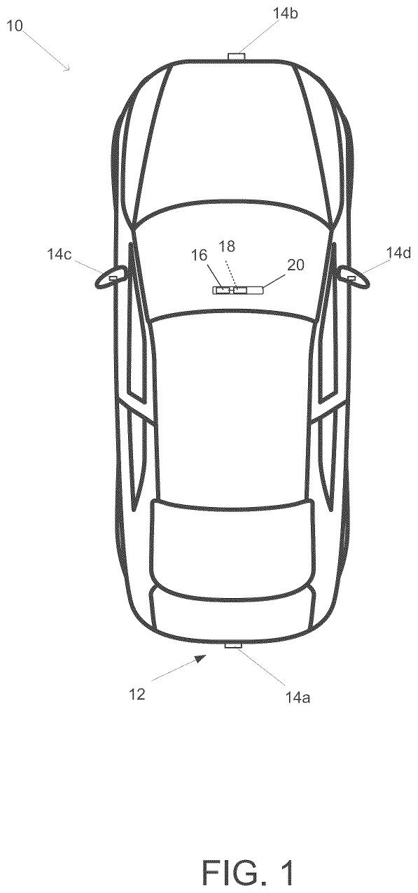

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Many modern vehicles are equipped with cameras and vision systems to offer various advanced driving assistance systems (ADASs). Image quality holds vital importance to these systems. That is, it is a foundational factor for autonomous vehicles to effectively “see” and comprehend the environment. Precise object detection, including pedestrians, other vehicles, and obstacles, relies on clear images. The reliability of a perception system (i.e., a system that performs object detection) is directly affected by the quality of the images, which is crucial for safety in critical conditions. For example, image quality may be degraded by glare, low light conditions, reflections, adverse weather conditions, and obstructed views. Image signal processing (ISP) pipeline, multi-sensor fusion, high-resolution cameras, and anti-glare systems may improve image quality and reduce these degradations. It is advantageous for the vision system to resolve image quality issues via detecting and enhancing images for better perception as this will increase the accuracy and reliability of the system. It is also advantageous to process image quality issues without compromising outputs of perception systems. Because autonomous vehicles and ADASs use the images to determine objects and/or obstacles and notify the driver and/or maneuver the vehicle in response to the objects or obstacles, it is also advantageous to determine and perform image enhancement in real time.

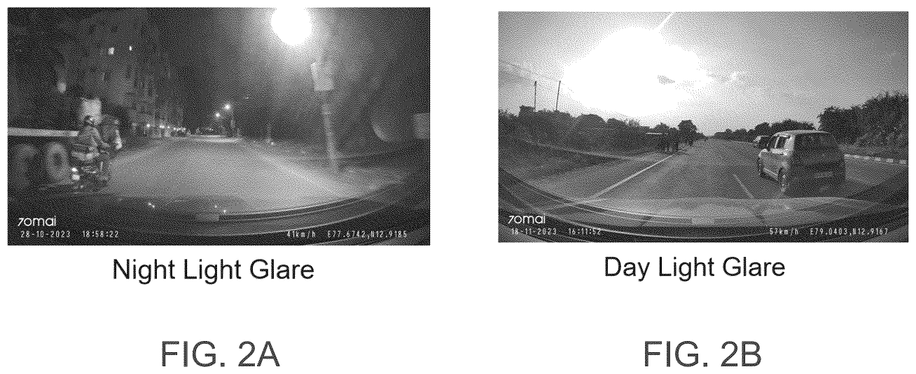

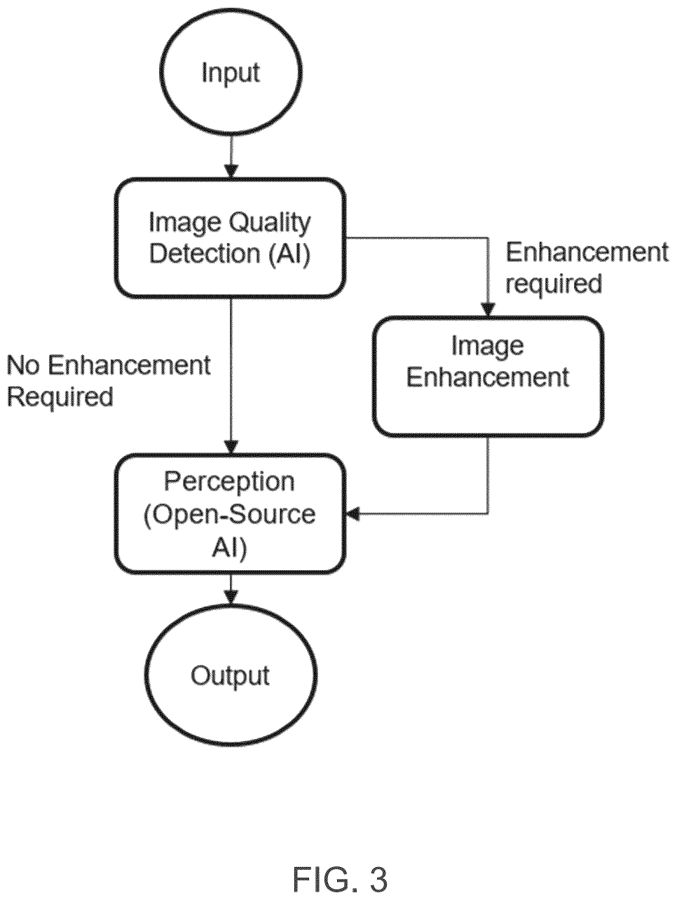

Implementations herein include a system for deploying artificial intelligence to detect and determine image quality. The system autonomously determines whether to implement image enhancement based on its analysis. For example, as shown in FIGS. 2A and 2B, the system may detect glare during night conditions (FIG. 2A) and detect glare during day conditions (FIG. 2B). The system may provide the improved image to another system of the vehicle (e.g., a perception system) for enhanced predictions. This may result in an increase of true positives and a decrease in false positives for the perception system or other systems relying on the improved image. For example, the perception system, using the improved image, may make predictions with greater confidence. Additionally, the system enables better prediction confidence for a self-driving vehicle's perception output, which enhances the vehicle's overall self-driving performance.

Referring now to FIG. 3, the system includes one or more cameras that capture image data. The system determines an image quality of at least a portion of the frames of image data captured by the one or more cameras. The system may determine whether the image quality of a respective frame of image data meets or exceeds a quality threshold. When the frame of image data meets the quality threshold, the system may provide the frame of image data directly to another system for use. For example, the system provides the image to the perception system, and the perception system may use the frame of image data to make one or more predictions (e.g., detect objects, detect scenarios, detect conditions around the vehicle, etc.). In some examples, the perception system may use a model such as a neural network trained on curated datasets of images representative of and/or collected in real-world driving scenarios to make the predictions. As shown in FIG. 3, optionally, the system first receives an input image (i.e., a frame of image data), a model (such as a neural network) detects and/or classifies any quality issues in the image, and when a quality issue is detected, the system automatically and in real-time enhances the image to compensate for the quality issue and provides the enhanced image to other systems for use in other features or functions of the vehicle (e.g., for an ADAS or the like). The system may determine more than one quality issues in the image and enhance the image based on the more than one quality issues before providing the enhanced image as output.

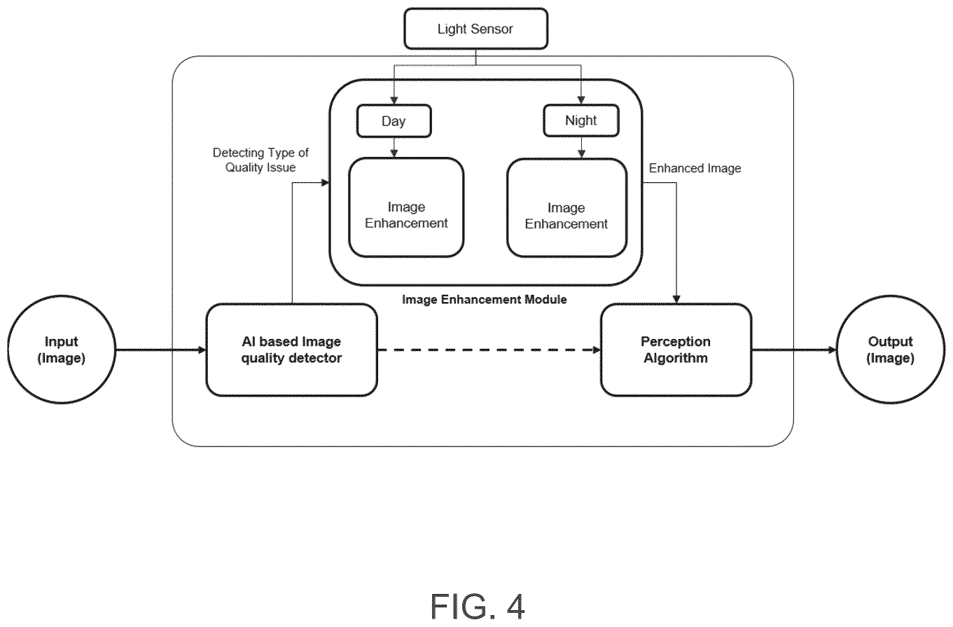

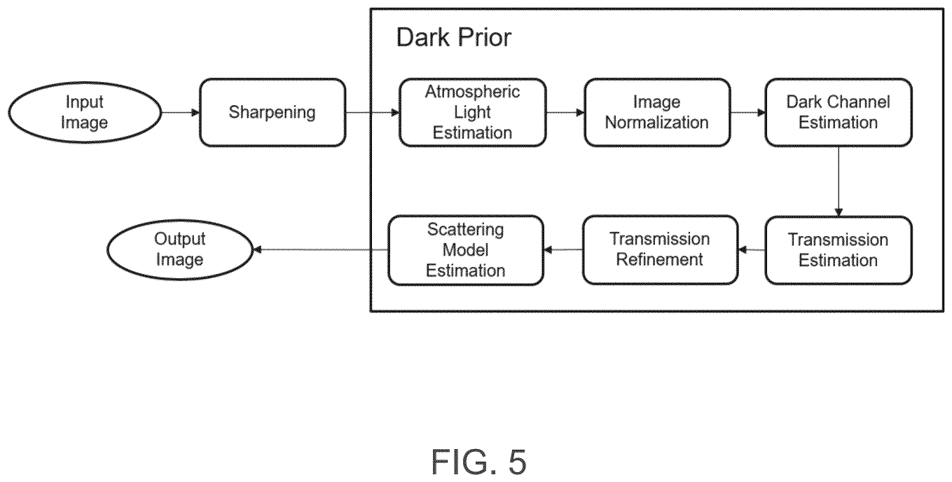

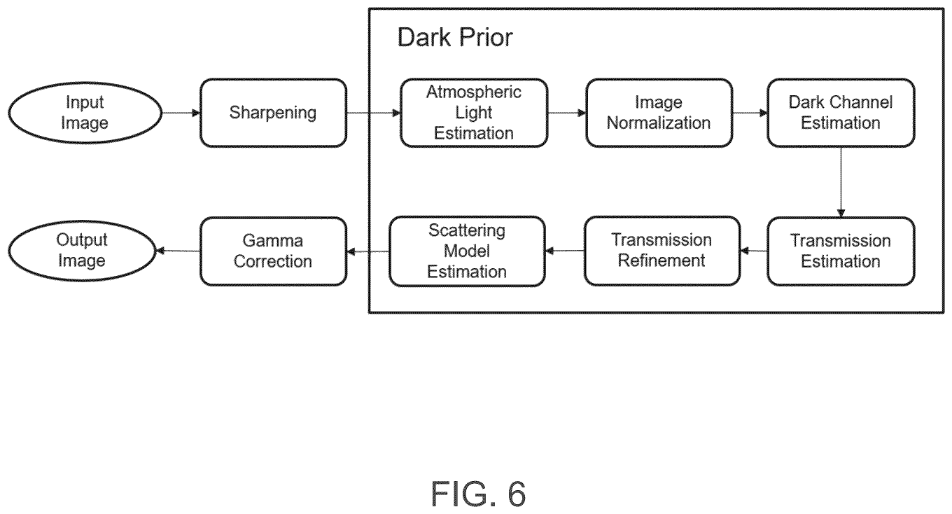

Referring now to FIG. 4, the system may include an ambient light sensor to determine whether conditions reflect day conditions or night conditions. At an image enhancement module, the system may select image enhancements depending on whether the system determines it is daylight condition (i.e., there is a greater than a threshold amount of ambient light) or night light and/or low light conditions (i.e., there is less than the threshold amount of ambient light). That is, the image enhancement techniques that the system selects from may be filtered or otherwise based on current ambient light levels. FIGS. 5 and 6 illustrate exemplary block diagrams for night light enhancement (FIG. 5) and daylight enhancement (FIG. 6). Image enhancement for both daylight condition or low light condition images may include sharpening and dark channel prior. For example, dark channel prior may include atmospheric light estimation, image normalization, dark channel estimation, transmission estimation, transmission refinement, and scattering model estimation. Optionally, the daylight enhancement may include gamma correction while the night light enhancement may not include gamma correction. Other techniques may be included for use in either or both of the night light enhancements and daylight enhancements based on each technique's suitability to different ambient light conditions.

When the frame of image data fails to meet or exceed the quality threshold, the system may first perform image enhancement on the frame of image data. The image enhancement may include improving focus, reducing glare, cropping the image, dewarping the image, etc. Once the frame of image data has been enhanced, the enhanced frame of image data may be provided to the perception system.

The system may include an Al-based image quality enhancement system capable of detection and enhancement. For example, the system includes a model such as a neural network (e.g., a convolutional neural network (CNN)) based Al system to detect the image quality issues with the image and determine whether to apply image enhancement or not. The model, which may be a deep learning model, may be trained on a curated dataset that incorporates glare-based detection and other enhancement capabilities. For example, the model may detect low light conditions, reflections, and dirty or partially blocked camera lenses (i.e., lenses that are soiled or occluded). Training the model may include a plurality of annotated training samples that, during training, are used to update weights (i.e., parameters) of the model. The model may be trained on datasets curated with images representative of and/or collected in real-world driving scenarios. Additionally or alternatively, the model may also be trained based, at least partially, on open-source datasets. The model may be trained to classify the image into one or more categories of differing image deficiencies. For example, the model may classify the image as having low-light conditions, glare conditions, reflection conditions, etc.

Optionally, the model detects or determines a deficiency in the image and selects, from among a plurality of image enhancement techniques, a particular enhancement technique best suited for the determined deficiency. For example, when the model determines that a frame of image data has a threshold amount of glare present, the model may select and/or employ a glare reduction or compensation image enhancement technique. Conversely, when the model determines that a frame of image data suffers from low light conditions, the model may select and/or employ a low light condition image enhancement technique. In some examples, when the frame of image data suffers from two or more deficiencies (i.e., the model predicts with a threshold amount of confidence that the frame suffers from two or more deficiencies), the model may select two or more corresponding image enhancement techniques.

The system then provides the enhanced image to the perception system for better prediction in real-time. For example, object detection systems typically have a very narrow window to detect and classify an object in order to react appropriately to the object (e.g., by slowing or maneuvering the vehicle). Thus, the system automatically and in real-time determines whether an image requires enhancement and, when so, enhances the image such that the enhanced image is still fresh for use for object detection systems and the like. This allows the object detection system to operate with increased accuracy and/or reliability (e.g., increasing the accuracy of object classification).

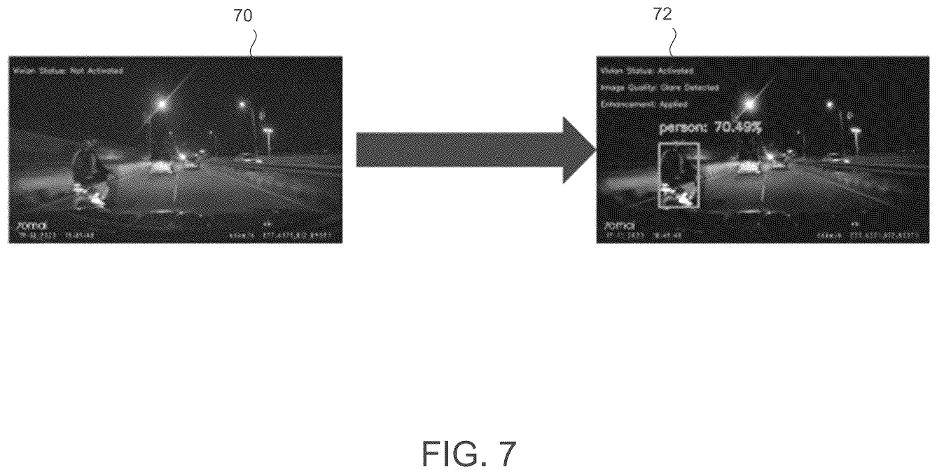

FIG. 7 shows a first image 70 where excessive glare is detected or determined by the enhancement system. In this example, the glare (e.g., from streetlamps, headlights, reflections, etc.) causes the image to fail to meet or exceed the quality threshold. Accordingly, the frame undergoes image enhancement. The enhanced image 72 has reduced glare, which allows the perception system to make more accurate predictions. The model may be capable of distinguishing image quality issues such as glare from oncoming vehicles and sunlight.

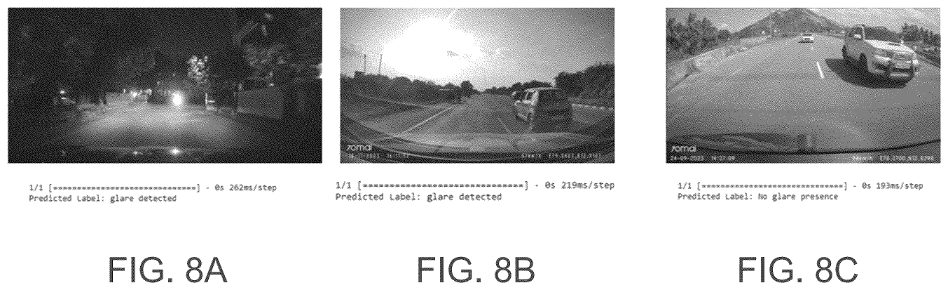

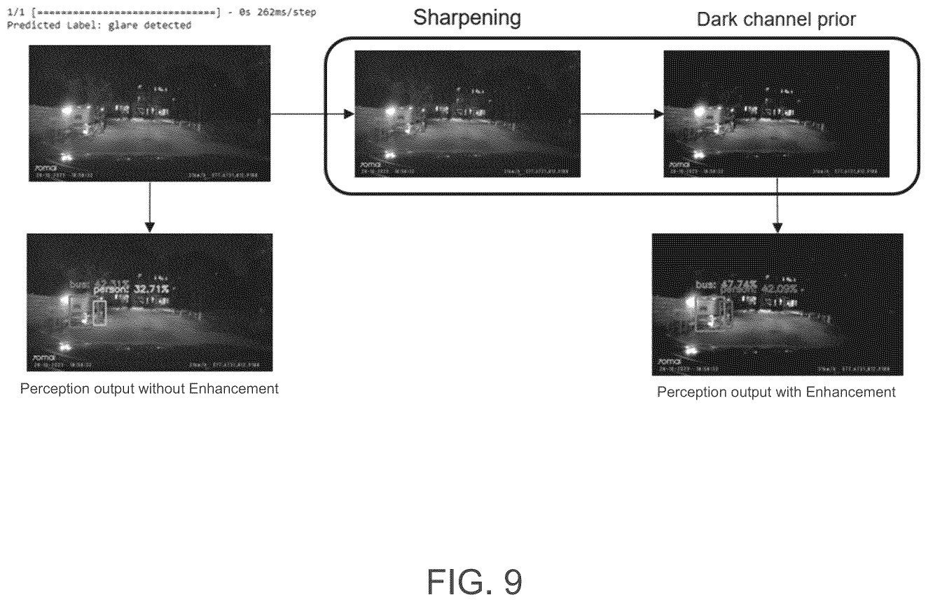

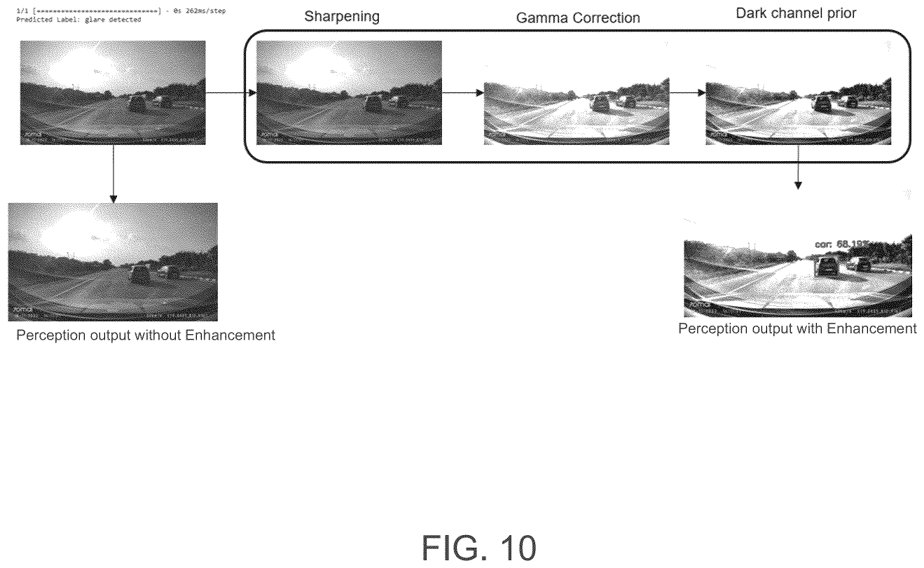

As shown in FIGS. 8A-8C, the model may process, as input, frames of image data captured by a camera of the vehicle (e.g., a forward viewing camera) and detect glare in daytime or nighttime conditions. In these examples, the model classifies two images as containing glare (FIGS. 8A and 8B) and classifies a third image as containing no glare (FIG. 8C). FIG. 9 includes an exemplary flowchart for processing images with glare in nighttime conditions. FIG. 10 includes another exemplary flowchart for processing images with glare in daytime conditions. In each case, the model determines or predicts glare is present in a frame of image data. The system then selects an appropriate enhancement technique (e.g., based on environmental conditions, such as the amount of ambient light) and enhances the image with the enhancement technique (e.g., sharpening to reduce glare).

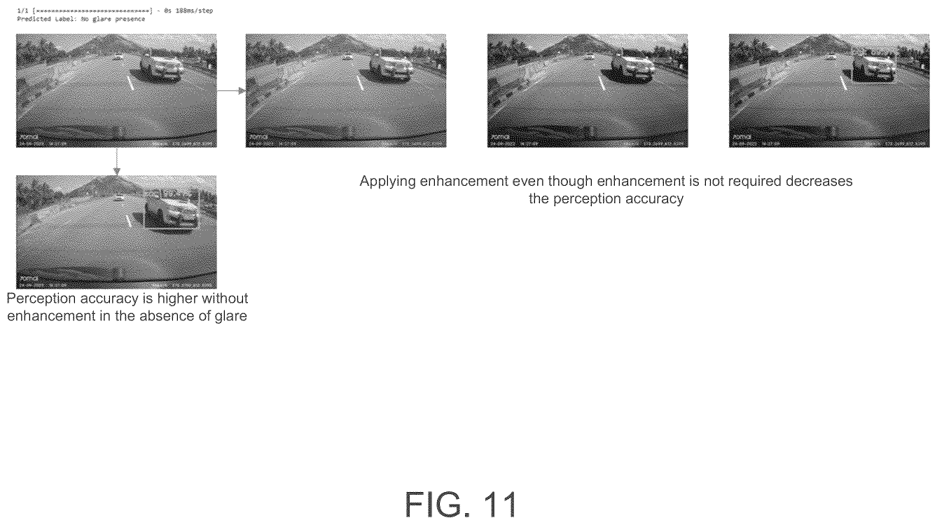

While image enhancement may be applied to all image frames, as shown in FIG. 11, enhancing frames when the enhancement is not needed (e.g., enhancing a frame for glare when no glare is present) can result in a reduction in performance (e.g., perception detection quality may be reduced). In the example shown in FIG. 11, glare enhancement techniques are applied to an image with no glare present. Due to the unnecessary glare enhancement of the image, the perception system's detection confidence decreases by 10% compared with the perception system's detection confidence when processing the same image without glare enhancements. Thus, it is advantageous to determine whether a frame of image data requires the enhancement or would benefit from the enhancement prior to enhancing the frame. Accordingly, the model may determine that the quality of an image is satisfactory (e.g., exceeds or meets an image quality threshold) and provide the image to the perception system without enhancing the image.

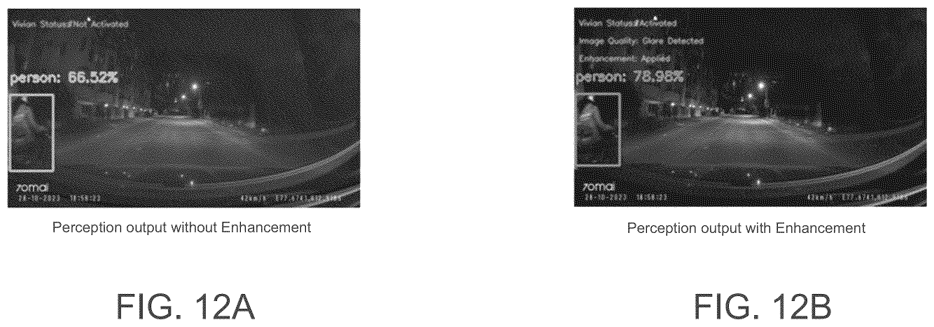

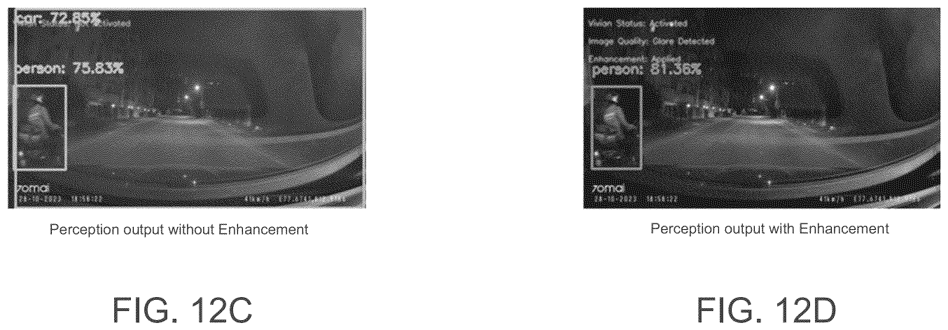

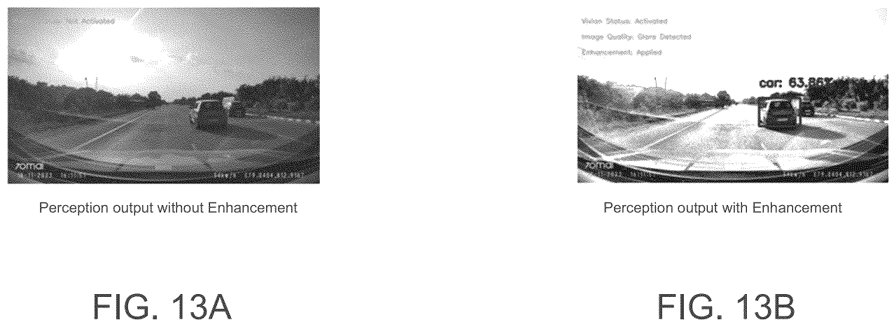

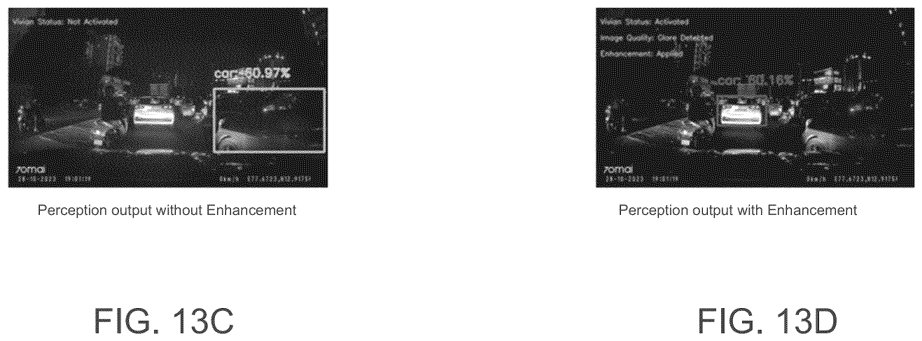

Thus, as shown in the examples of FIGS. 12A-13D, the system may improve confidence in predictions (FIGS. 12A and 12B), reduce false positives (FIGS. 12C and 12D), and increase true positives (FIGS. 13A-13D) for object detection, classification, and the like. In one example, a perception system, based on an image that has not been processed by the system, may correctly determine that a person is present, but with low confidence (FIG. 12A). In contrast, the same perception system may again correctly determine that a person is present, but with a higher confidence, based on the same image after it has been enhanced by the system (FIG. 12B). In another example, a perception system output based on an image that has not been processed by the system may produce a false-positive determination that a car is present in an environment where no car is present (FIG. 12C). In contrast, the same perception system may correctly determine that no car is present based on the same image after it has been enhanced by the system (FIG. 12D).

The system may also increase true positives (FIGS. 13A-13D). The model may accurately detect glare and other deficiencies in frames of image data in different environmental conditions (e.g., day/night). For example, in a high-glare condition caused by sunlight, a perception system, based on an image that has not been processed by the system, may fail to identify a vehicle in the image data (FIG. 13A). In contrast, the same perception system may successfully identify the vehicle based on the same image after the image has been enhanced by the model (FIG. 13B). In FIG. 13C, without enhancement, the perception system identifies the wrong vehicle to track or follow, which could result in poor performance of an autonomous or semi-autonomous ASAS. In contrast, in FIG. 13D, after enhancing the image, the perception system is able to correctly detect and identify the lead vehicle.

The model may include a deep neural network such as a CNN. The deep neural network may determine image enhancements to be performed based on the determined image quality. The system may include a perception system that includes a neural network that is pre-trained on real-world datasets before it is implemented into a vehicle system or an ADAS. The model may be trained (i.e., have the values of weights and/or parameters updated) using training data recorded from vehicle cameras. The model may execute on an ECU or other processor disposed at the vehicle. The model may update (e.g., fine-tune) based on image data captured during inference and based on feedback from the driver (e.g., steering and/or braking input).

An autonomous vehicle and/or ADAS may control the vehicle and/or provide notifications to a driver of a vehicle based on objects detected in image data captured by one or more cameras of the vehicle. Thus, the quality of the image data affects the ability of a perception system to provide accurate object detections to the autonomous vehicle and/or ADAS, which affects the accuracy of vehicular control outputs and/or notifications. Image enhancements may improve object detection accuracy based on low-quality image data, but image enhancement may also degrade object detection accuracy when those enhancements are not needed. A system using a non-deterministic model to detect and determine quality of image data allows the image quality determinations to be made in real-time. Accordingly, the model maximizes object detections by allowing the system to selectively perform image enhancements before performing the object detection at the perception system. Thus, the system enables self-driving vehicles and ADASs to more accurately control the vehicle and/or provide notifications to a driver of the vehicle based on the objects detected by the perception system. The autonomous vehicle or ADAS may control the vehicle by maneuvering the vehicle via steering inputs, throttle inputs, braking inputs, etc. The autonomous vehicle or ADAS may notify the driver of the vehicle using audible notifications, visual notifications, haptic notifications, etc.

A vehicular vision system may include a camera disposed at a vehicle equipped with the vehicular vision system and viewing exterior of the vehicle. The camera is operable to capture frames of image data, and the camera may include a CMOS imaging array, where the CMOS imaging array includes at least one million photosensors arranged in rows and columns. An ECU includes electronic circuitry and associated software. Frames of image data captured by the camera may be transferred to and may be processed at the ECU. The vehicular vision system may determine, responsive to processing at the ECU of frames of image data captured by the camera and transferred to the ECU, whether a quality of a frame of image data satisfies a quality threshold. Responsive to determining that the quality of the frame of image data fails to satisfy the quality threshold, the vehicular vision system may enhance the frame of image data. The vehicular vision system may generate, using the enhanced frame of image data, a prediction for an advanced driving assistance system (ADAS) of the vehicle.

In some examples, the vehicular vision system may determine that the quality of the frame of image data fails to satisfy the quality threshold using a neural network. In further examples, the neural network may be a convolutional neural network. In other examples, the vehicular vision system may determine that the quality of the frame of image data fails to satisfy the quality threshold based on glare present in the frame of image data. In further examples, the vehicular vision system may enhance the frame of image data by reducing the glare present in the frame of image data. In other examples, the ADAS of the vehicle may control, based on the prediction, at least one selected from the group consisting of (i) steering of the vehicle and (ii) speed of the vehicle.

In some examples, the prediction may include determining an object depicted by the image data. In other examples, the vehicular vision system may enhance the frame of image data by selecting an enhancement technique from a plurality of available enhancement techniques. In further examples, the plurality of available enhancement techniques may include at least a daytime glare enhancement technique and a nighttime glare enhancement technique that is different from the daytime glare enhancement technique. In still further examples, the vehicular vision system may select the enhancement technique based on at least one selected from the group consisting of (i) environmental conditions and (ii) a classification of the quality of the frame of image data. In even further examples, the environmental conditions may include an amount of ambient light.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354;US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system, wherein the camera views exterior of the vehicle, and wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular vision system determines, at least in part via processing at the ECU of frames of image data captured by the camera and transferred to the ECU, whether a quality of a frame of image data satisfies a quality threshold;
wherein, based at least in part on determining that the quality of the frame of image data fails to satisfy the quality threshold, the vehicular vision system enhances the frame of image data; and
wherein the enhanced frame of image data is processed at the ECU for an advanced driving assistance system (ADAS) of the vehicle.

2. The vehicular vision system of claim 1, wherein the vehicular vision system determines that the quality of the frame of image data fails to satisfy the quality threshold using a neural network.

3. The vehicular vision system of claim 2, wherein the neural network comprises a convolutional neural network.

4. The vehicular vision system of claim 1, wherein the vehicular vision system determines whether the quality of the frame of image data satisfies the quality threshold based on glare present in the frame of image data.

5. The vehicular vision system of claim 4, wherein the vehicular vision system enhances the frame of image data by reducing the glare present in the frame of image data.

6. The vehicular vision system of claim 1, wherein the ADAS of the vehicle controls, based on the enhanced frame of image data, at least one selected from the group consisting of (i) steering of the vehicle and (ii) speed of the vehicle.

7. The vehicular vision system of claim 6, wherein the ECU processes the enhanced frame of image data to classify an object depicted by the image data.

8. The vehicular vision system of claim 1, wherein the vehicular vision system enhances the frame of image data by selecting an enhancement technique from a plurality of available enhancement techniques.

9. The vehicular vision system of claim 8, wherein the plurality of available enhancement techniques comprises at least (i) a daytime glare enhancement technique and (ii) a nighttime glare enhancement technique that is different from the daytime glare enhancement technique.

10. The vehicular vision system of claim 8, wherein the vehicular vision system selects the enhancement technique based on at least one selected from the group consisting of (i) environmental conditions and (ii) a classification of the quality of the frame of image data.

11. The vehicular vision system of claim 10, wherein the environmental conditions comprise an amount of ambient light.

12. The vehicular vision system of claim 1, wherein, based at least in part on determining that the quality of the frame of image data satisfies the quality threshold, the frame of image data is processed at the ECU for the ADAS of the vehicle without enhancement.

13. A vehicular vision system, the vehicular vision system comprising:
a camera disposed at a vehicle equipped with the vehicular vision system, wherein the camera views exterior of the vehicle, and wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular vision system determines, at least in part via processing at the ECU of frames of image data captured by the camera and transferred to the ECU, whether a quality of a frame of image data satisfies a quality threshold using a neural network;
wherein, based at least in part on determining that the quality of the frame of image data fails to satisfy the quality threshold, the vehicular vision system enhances the frame of image data to reduce glare present in the frame of image data; and
wherein the enhanced frame of image data is processed at the ECU for an advanced driving assistance system (ADAS) of the vehicle.

14. The vehicular vision system of claim 13, wherein the neural network comprises a convolutional neural network.

15. The vehicular vision system of claim 13, wherein the ADAS of the vehicle controls, based on the enhanced frame of image data, at least one selected from the group consisting of (i) steering of the vehicle and (ii) speed of the vehicle.

16. The vehicular vision system of claim 15, wherein the ECU processes the enhanced frame of image data to classify an object depicted by the image data.

17. A vehicular vision system, the vehicular vision system comprising:
a camera disposed at a vehicle equipped with the vehicular vision system, wherein the camera views exterior of the vehicle, and wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular vision system determines, at least in part via processing at the ECU of frames of image data captured by the camera and transferred to the ECU, whether a quality of a frame of image data satisfies a quality threshold;
wherein, based at least in part on determining that the quality of the frame of image data fails to satisfy the quality threshold, selects an enhancement technique from a plurality of available enhancement techniques;
wherein the vehicular vision system enhances the frame of image data using the selected enhancement technique;
wherein the enhanced frame of image data is processed at the ECU for an advanced driving assistance system (ADAS) of the vehicle; and
wherein, based at least in part on determining that the quality of the frame of image data satisfies the quality threshold, the frame of image data is processed at the ECU for the ADAS of the vehicle without enhancement.

18. The vehicular vision system of claim 17, wherein the plurality of available enhancement techniques comprises at least (i) a daytime glare enhancement technique and (ii) a nighttime glare enhancement technique that is different from the daytime glare enhancement technique.

19. The vehicular vision system of claim 17, wherein the vehicular vision system selects the enhancement technique based on at least one selected from the group consisting of (i) environmental conditions and (ii) a classification of the quality of the frame of image data.

20. The vehicular vision system of claim 19, wherein the environmental conditions comprise an amount of ambient light.
